(19) United States
(12) Patent Application Publication
(10) Pub. No.: US 2009/0296422 A1
(43) Pub. Date: Dec. 3, 2009

(54) Optical Film and backlight Module using the same

(76) Inventors: Chi-Lung LEE, Hsinchu (TW); Wen-Hsin Lo, Hsinchu (TW)

Correspondence Address: HDLS Patent & Trademark Services, P.O. BOX 220746, CHANTILLY, VA, 20153-0746, US

(21) Appl. No.: 12/249,168

(22) Filed: Oct. 10, 2008

(30) Foreign Application Priority Data
Jun. 2, 2008 (TW) 097120479

(51) Int. Cl. F21V 8/00; G02B 5/18

(52) U.S. Cl. 362/558; 359/569; 362/97.1

(57) ABSTRACT

An optical film includes a substrate and a plurality of grating structures. The substrate has a light incident surface and a light exit surface opposite to the light incident surface, wherein the light exit surface includes a plurality of semi-cylinder surfaces disposed side by side. The grating structures are disposed on portions of the light exit surface, and an extending direction of each of the grating structures is substantially parallel with an extending direction of each of the semi-cylinder surfaces. The optical film improves uniformity of a plane light source. Further, a backlight module using the optical film is provided.

### BACKGROUND

1. Field of the Invention

The present invention relates to an optical film, and particularly to an optical film for a backlight module and a backlight module using the optical film.

2. Description of Related Art

With continuous progress, flat displays are widely used due to their attractive characteristics such as light weight, compact volume and low power consumption. Familiar flat displays includes liquid crystal displays (LCDs), plasma display panels (PDPs), organic light emitting diode displays, (OLED displays). Generally, LCDs are the most popular.

The LCD includes an LCD panel and a backlight module, wherein the backlight module is for providing a plane light source to the LCD panel. Therefore, quality of the plane light source provided by the backlight module is closely related to display quality of the LCD.

FIG. 1A is a schematic view of a conventional backlight module. Referring to FIG. 1A, the conventional backlight module 100 includes a light box 110, a plurality of cold cathode fluorescent lamps (CCFLs) 120, a diffuser plate 130 and a diffuser film 140. The CCFLs 120 are arranged apart from each other in the light box 110, the diffuser plate 130 is disposed above the light box 110, and the diffuser film 140 is disposed above the diffuser plate 130. Furthermore, each of the CCFLs 120 provides a light beam 122 to the diffuser plate 130. The diffuser plate 130 converts the light beam 122 into a plane light source, and the diffuser film 140 uniforms the plane light source.

Areas A1 of a light exit surface 132 of the diffuser plate 130 are right above the CCFLs 120. In the conventional technique, due to the CCFLs 120 being arranged apart from each other in the light box 110, brightness of the areas A1 is relatively higher when the plane light source emits from the light exit surface 132, and this reduces uniformity of the plane light source. Further, even after the plane light source passing through the diffuser film 140, the uniformity of the plane light source is still bad.

FIG. 1B is a schematic view of another conventional backlight module. Referring to FIG. 1B, comparing to the backlight module 100 in FIG. 1A, the conventional backlight module 100′ further includes two brightness enhancement films (BEFs) 150a and 150b. The BEFs 150a and 150b respectively have a plurality of triangular prisms 152, wherein an extending direction of each of the triangular prisms 152 of the BEF 150a is perpendicular to an extending direction of each of the triangular prisms 152 of the BEF 150b. More specifically, triangular prisms 152 of the BEF 150a extend along a Z axis, and triangular prisms 152 of the BEF 150b extend along an X axis.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF SUMMARY

The present invention relates to an optical film to improve uniformity of a plane light source provided by a backlight module.

The present invention further relates to a backlight module for improving uniformity of a plane light source.

Other objects and advantages of the present invention can be understood from technical features disclosed by the present invention.

In order to achieve at least one of the above-mentioned advantages, an optical film in accordance with an embodiment of the present invention is provided. The optical film includes a substrate and a plurality of grating structures. The substrate has a light incident surface and a light exit surface opposite to the light incident surface, wherein the light exit surface includes a plurality of semi-cylinder surfaces disposed side by side. The grating structures are disposed on portions of the light exit surface, and an extending direction of each of the grating structures is substantially parallel with an extending direction of each of the semi-cylinder surfaces.

In order to achieve at least one of the above-mentioned advantages, a backlight module in accordance with an embodiment of the present invention is provided. The backlight module includes an optical plate, at least a lamp and the above-mentioned optical film. The lamp is disposed beside to the optical plate for providing a light beam to the optical plate. The optical plate is for converting the light beam to a plane light source, and the optical film is disposed above the optical plate.

In the embodiments of the present invention, the plane light source is diffracted by the grating structures of the optical film to improve uniformity of the plane light source. Therefore, the uniformity of the plane light source provided by the backlight module using the optical film is promoted.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a schematic view of a conventional backlight module.

FIG. 1B is a schematic view of another conventional backlight module.

FIG. 2 is a schematic view of a backlight module according to an embodiment of the present invention.

FIG. 3 is a schematic three-dimensional view of an optical plate and an optical film shown in FIG. 2.

FIGS. 4 and 5 are two schematic three-dimensional views of two optical films according to another two embodiments of the present invention.

FIG. 6 is a schematic view of a backlight module according to another embodiment of the present invention.

FIG. 7 is a schematic three-dimensional view of an optical film and a brightness enhancement film shown in FIG. 6.

FIG. 8 is a schematic view of a backlight module according to another embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

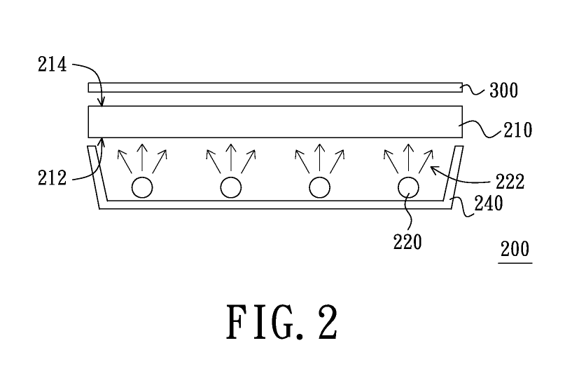

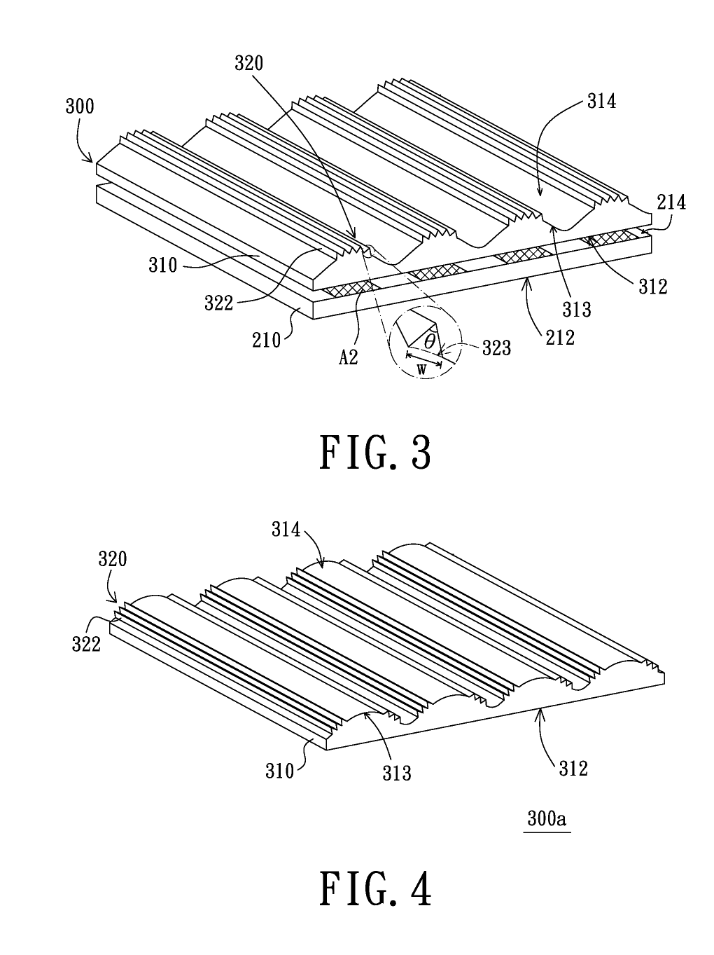

FIG. 2 is a schematic view of a backlight module according to an embodiment of the present invention and FIG. 3 is a schematic three-dimensional view of an optical plate and an optical film shown in FIG. 2. Referring to FIGS. 2 and 3, the backlight module 200 according to the present embodiment includes an optical plate 210, a plurality of lamps 220 and an optical film 300. The optical plate 210 is, for example, a diffuser plate, and the lamps 220 may be, but not limited to, cold cathode fluorescent lamps (CCFLs) or light emitting diodes (LEDs). The lamps 220 are disposed below the optical plate 210 to respectively provide a light beam 222 to a light incident surface 212 of the optical plate 210. The optical plate 210 is for converting the light beams 222 to a plane light source. The optical film 300 is disposed above the optical plate 210. Moreover, the backlight module 200 may further include a light box 240, and the lamps 220 are disposed in the light box 240.

Furthermore, the optical film 300 includes a substrate 310 and a plurality of grating structures 320, wherein the substrate 310 and the grating structures 320 are, for example, integrated into one piece. The substrate 310 has a light incident surface 312 and a light exit surface 314 opposite to the light incident surface 312, wherein the light incident surface 312 is opposite to the optical plate 210. The light exit surface 314 includes a plurality of semi-cylinder surfaces 313 disposed side by side. The grating structures 320 are disposed on portions of the light exit surface 314.

More specifically, in the present embodiment, the grating structures 320 are disposed on tops of the semi-cylinder surfaces 313, and an extending direction of each of the grating structures 320 is substantially parallel with an extending direction of each of the semi-cylinder surfaces 313. Further, each of the grating structures 320 may include a plurality of triangular prisms 322 disposed side by side, and an extending direction of each of the triangular prisms 322 is substantially parallel with the extending direction of each of the semi-cylinder surfaces 313. Moreover, a vertex angle θ of each of the triangular prisms 322 is, for example, between 30 degrees and 60 degrees, and width W of a bottom 323 of each of the triangular prisms 322 is, for example, between 133 micrometers and 288 micrometers.

In the present embodiment, the light beams 222 provided by the lamps 220 is converted into the plane light source by the optical plate 210, and the plane light source emits from a light exit surface 214 of the optical plate 210 and then is incident to the optical film 300 from the light incident surface 312 of the optical film 300. Areas A2 of the light exit surface 214 of the optical plate 210 are right above the lamps 220. Due to the lamps 220 being arranged apart from each other, brightness of the areas A2 is relatively higher when the plane light source emits from the light exit surface 214 of the optical plate 210, and this could result in periodically alternative bright lines and dark lines. However, in the present embodiment, because the grating structures 320 of the optical films 300 are disposed right above the areas A2 of the light exit surface 214 and portions of the plane light source are diffracted by the grating structures 320 when passing through the grating structures 320, the bright lines and dark lines are eliminated after the plane light source emitting from the light exit surface 314 of the optical film 300, and uniformity of the plane light source is consequently improved. Therefore, the optical film 300 according to the present embodiment may effectively improve the uniformity of the plane light source. Furthermore, because the uniformity of the plane light source provided by the backlight module 200 using the optical film 300 is improved, display quality of a liquid crystal display (LCD) using the backlight module 200 is promoted.

In the present embodiment, the grating structures 320 are used to diffract the light beams 222 passing through thereon to improve the uniformity of the plane light source. The position of the grating structures 320 may be changed depending on the position of the bright lines and dark lines of the plane light source, so the position of the grating structures 320 is not limited to tops of the semi-cylinder surfaces 313. Another two optical films according to other embodiments will be recited below to illustrate other possible position of the grating structures. It should be noted that the position and the structure of the grating structures of the optical films according to the embodiments of the present invention is properly changed to satisfy different requirements. One skilled in the art should understand the spirit and the technical features of the present invention after reading the embodiments of the present invention and then provide other proper embodiments according to the spirit of the present invention.

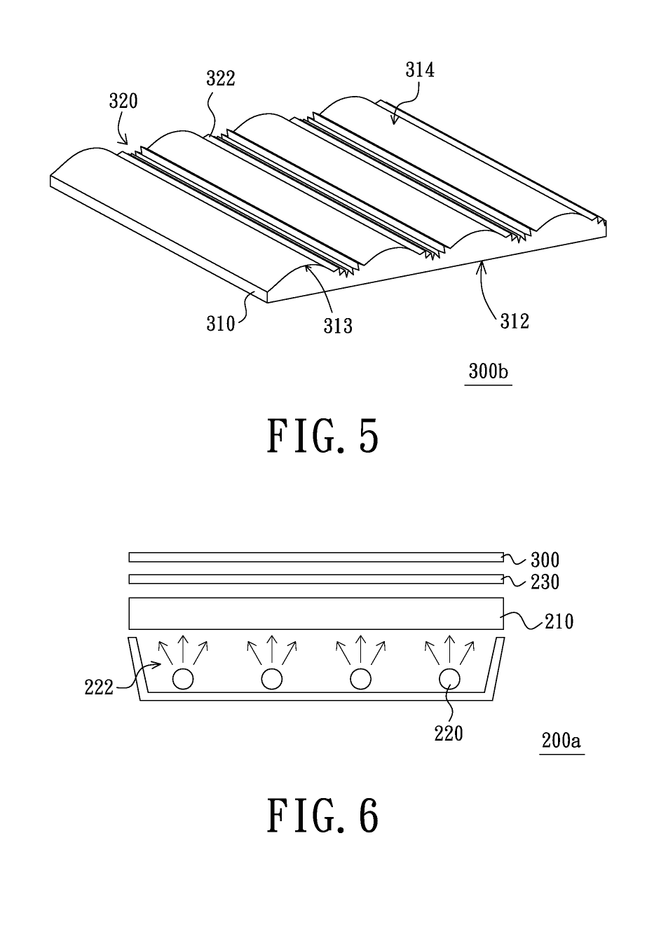

FIGS. 4 and 5 are two schematic three-dimensional views of two optical films according to another two embodiments of the present invention. Referring to FIG. 4, in the optical film 300a of the present embodiment, each of the grating structures 320 is disposed between a top of one of the semi-cylinder surfaces 313 and a border between the two adjacent semi-cylinder surfaces 313. Further, referring to FIG.5, in the optical film 300b of the present embodiment, each of the grating structures 320 is disposed at a border between two adjacent semi-cylinder surfaces 313. Moreover, the optical film 300 of the backlight module 200 of FIG. 2 may be replaced by the optical film 300a or the optical film 300b.

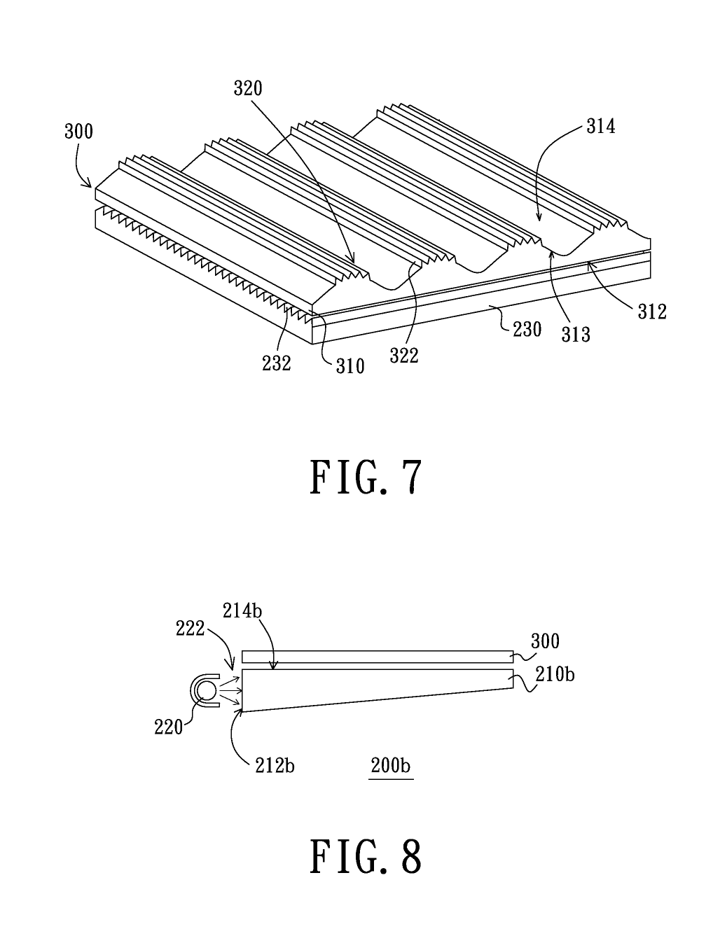

FIG. 6 is a schematic view of a backlight module according to another embodiment of the present invention, and FIG. 7 is a schematic three-dimensional view of an optical film and a brightness enhancement film shown in FIG. 6. Referring to FIGS. 6 and 7 the backlight module 200a of the present embodiment is similar to the backlight module 200 of FIG. 2 except that the backlight module 200a further includes a brightness enhancement film (BEF) 230. The BEF 230 is disposed between the optical plate 210 and the optical film 300. The BEF 230 includes a plurality of triangular prisms 232 and the triangular prisms 232 are parallel with each other. An extending direction of each of the triangular prisms 232 is substantially perpendicular to the extending direction of each of the semi-cylinder surfaces 313. In other words, the extending direction of each of the triangular prisms 232 is substantially perpendicular to the extending direction of each of the grating structures 320.

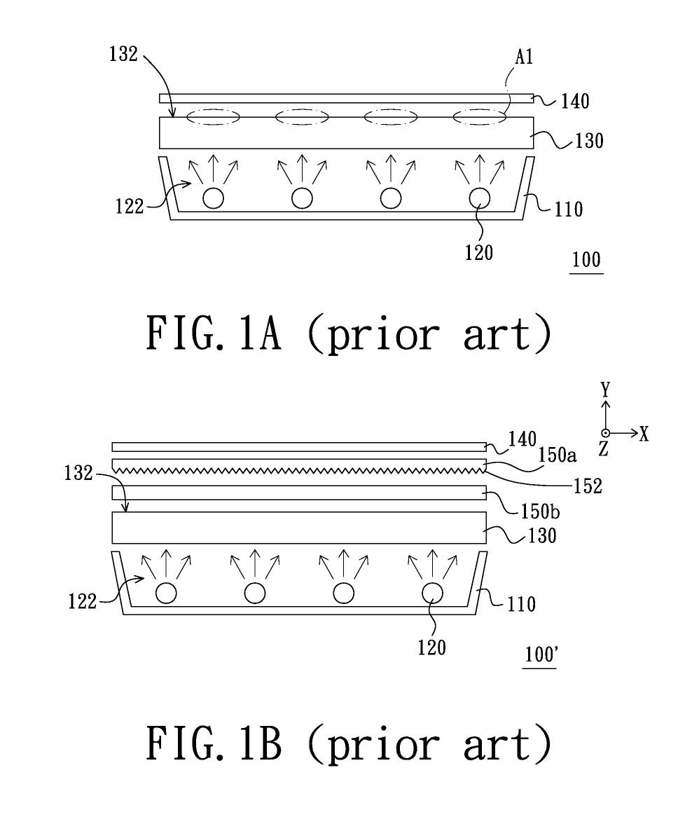

The conventional backlight module 100′ of FIG.1B includes two BEFs 150a and 150b, and the extending direction of each of the triangular prisms 152 of the BEF 150a is perpendicular to the extending direction of each of the triangular prisms 152 of the BEF 150b. However, in the present embodiment, because of the optical film 300 having the grating structures 320, the optical film 300 may also be served as the BEF 230. Therefore, the present embodiment needs only one BEF 230 and the cost of the backlight module 200a is consequently reduced. Further, the optical film 300 of the backlight module 200a may be replaced by the optical film 300a (as shown in FIG. 4) or the optical film 300b (as shown in FIG. 5).

Although the backlight modules 200 and 200a are direct type backlight modules, the optical films 300, 300a and 300b may be also applied to edge type backlight modules. FIG. 8 is a schematic view of a backlight module according to another embodiment of the present invention. Referring to FIG. 8, the backlight module 200b of the present embodiment is an edge type backlight module. The backlight module 200b includes a lamp 220, an optical plate 210b and the optical film 300 of FIG. 3. The optical plate 210b is a light guide plate, and the lamp 220 is disposed beside a light incident surface 212b of the optical plate 210b to provide a light beam 222 to the optical plate 210b. The optical film 300 is disposed above a light exit surface 214b of the optical plate 210b.

Advantages of the backlight module 200b are similar to that of the backlight module 200 of FIG. 2 and will not be described in detail herein. Moreover, the optical film 300 of the backlight module 200b may be replaced by the optical film 300a (as shown in FIG. 4) or the optical film 300b (as shown in FIG. 5).

In summary, the present invention at least includes the following advantages:

1. The optical film has the grating structures and the grating structures are used to diffract the plane light source passing through thereon to eliminate the bright lines and dark lines. Therefore, the optical film is improved the uniformity of the plane light source.

2. Because the optical film is improved the uniformity of the plane light source, uniformity of the plane light source provided by the backlight module using the optical film is promoted. Therefore, display quality of the LCD is consequently promoted.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical film, comprising:
a substrate having a light incident surface and a light exit surface opposite to the light incident surface, wherein the light exit surface comprises a plurality of semi-cylinder surfaces disposed side by side; and
a plurality of grating structures disposed on portions of the light exit surface, wherein an extending direction of each of the grating structures is substantially parallel with an extending direction of each of the semi-cylinder surfaces.

2. The optical film as claimed in claim 1, wherein each of the grating structures is disposed at a border between two adjacent semi-cylinder surfaces.

3. The optical film as claimed in claim 1, wherein each of the grating structures is disposed between a top of one of the semi-cylinder surfaces and a border between the two adjacent semi-cylinder surfaces.

4. The optical film as claimed in claim 1, wherein the grating structures are respectively disposed on tops of the semi-cylinder surfaces.

5. The optical film as claimed in claim 1, wherein each of the grating structures comprises a plurality of triangular prisms disposed side by side, and an extending direction of each of the triangular prisms is substantially parallel with the extending direction of each of the semi-cylinder surfaces.

6. The optical film as claimed in claim 5, wherein a vertex angle of each of the triangular prisms is between 30 degrees and 60 degrees.

7. The optical film as claimed in claim 5, wherein width of a bottom of each of the triangular prisms is between 133 micrometers and 288 micrometers.

8. The optical film as claimed in claim 1, wherein the substrate and the grating structures are integrated into one piece.

9. A backlight module, comprising:
an optical plate;
at least a lamp disposed beside the optical plate for providing a light beam to the optical plate, and the optical plate being for converting the light beam into a plane light source;
an optical film disposed above the optical plate, the optical film comprising:
a substrate having a light incident surface and a light exit surface opposite to the light incident surface, wherein the light incident surface is opposite to the optical plate, and the light exit surface comprises a plurality of semi-cylinder surfaces disposed side by side; and
a plurality of grating structures disposed on portions of the light exit surface, wherein an extending direction of each of the grating structures is substantially parallel with an extending direction of each of the semi-cylinder surfaces.

10. The backlight module as claimed in claim 9, wherein each of the grating structures is disposed at a border between two adjacent semi-cylinder surfaces.

11. The backlight module as claimed in claim 9, wherein each of the grating structures is disposed between a top of one of the semi-cylinder surfaces and a border between the two adjacent semi-cylinder surfaces.

12. The backlight module as claimed in claim 9, wherein the grating structures are respectively disposed on tops of the semi-cylinder surfaces.

13. The backlight module as claimed in claim 9, wherein each of the grating structures comprises a plurality of triangular prisms disposed side by side, and an extending direction of each of the triangular prisms is substantially parallel with the extending direction of the semi-cylinder surfaces.

14. The backlight module as claimed in claim 13, wherein a vertex angle of each of the triangular prisms is between 30 degrees and 60 degrees.

15. The backlight module as claimed in claim 13, wherein width of a bottom of each of the triangular prisms is between 133 micrometers and 288 micrometers.

16. The backlight module as claimed in claim 9, wherein the substrate and the grating structures are integrated into one piece.

17. The backlight module as claimed in claim 9, wherein the optical plate comprises a light guide plate or a diffuser plate.

18. The backlight module as claimed in claim 9, further comprising a brightness enhancement film disposed between the optical plate and the optical film, wherein the brightness enhancement film comprises a plurality of triangular prisms, the triangular prisms are parallel with each other, and an extending direction of each of the triangular prisms is substantially perpendicular to the extending direction of each of the semi-cylinder surfaces.
